(19) United States
(12) Patent Application Publication
(10) Pub. No.: US 2006/0060515 A1
(43) Pub. Date: Mar. 23, 2006

(54) Capillary tube liquid transport device

(75) Inventors: Christopher C. Benevides, Tiverton, MA (US); Robert Collamati, Taunton, MA (US); Dennis DellaRovere, Mendon, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/211,066

(22) Filed: Aug. 24, 2005

Related U.S. Application Data
(63) Continuation of application No. PCT/US04/06712, filed on Mar. 5, 2004.
(60) Provisional application No. 60/452,742, filed on Mar. 7, 2003.

(51) Int. Cl. B01D 15/08

(52) U.S. Cl. 210/198.2; 73/61.52; 73/61.53

(57) ABSTRACT

A capillary tube liquid transport device adapted to make nano-sized capillaries (5 μm to 180 μm) resilient. A first nano-capillary has a first sleeve about an inlet end that provides a resilient surface for installation of a fitting. The nano-capillary has a second sleeve about an outlet end that deforms to grip the outlet end of the capillary and hold it tightly against a transport tubing capillary. An outer sleeve is attached to the two end sleeves retaining them in a spaced relationship and providing support for the capillaries. The entire device is relatively rugged and easy to handle.

### CROSS REFERENCE TO RELATED APPLICATIONS

This application claims benefit of and is a continuation of International Application No. PCT/US2004/006712, filed Mar. 5, 2004 and designating the United States, which claims benefit of a priority to U.S. Provisional Application No. 60/652,742, filed Mar. 7, 2003 (attorney docket number WAA-313). The content of which is expressly incorporated herein by reference in its entirety.

### FIELD OF THE INVENTION

The invention relates to a capillary structure that may include a column and more particularly to an assembly that stabilizes a capillary for ease of use in a liquid chromatography application.

### BACKGROUND OF THE INVENTION

Capillary liquid chromatography (LC) is a micro-version of traditional liquid chromatography. Capillary LC columns have extremely low solvent consumption and require ultra-low volumes of samples for analysis, and hence provide high efficiency separations. Nano LC is an even smaller version of Capillary LC, typically utilizing capillaries having an inner diameter between 5 μm and 180 μm. The smaller dimensions of Nano columns require even less solvent and samples for analysis. The output from the Nano LC columns is in sufficiently small volumes that it is well suited to provide samples to be analyzed by a mass spectrometer. Nano LC systems consist essentially of a nano-pump, a nano column, connection mechanisms for the nano column, a detector, and data processing capabilities. The connection mechanisms are an important part of the system, because they present opportunities for mismatch which at these volumes lead to bandspreading in the resultant analysis.

Different types of materials, such as fused silica, stainless steel, and polymer, have been used for capillary columns. Due to their unique features, fused silica capillaries are the most common for preparation of nano LC columns. It is easy to control the dimensions of fused silica capillaries during manufacturing and the capillaries do not deform when packed. Further, the wall of a fused silica capillary is smooth, which is very desirable for transport of small volumes of fluids.

However, fused silica capillaries have certain limitations. The most significant limitation stems from the brittle and fragile nature of the glass-like material from which they are made. The frangible nature of a thin, fused silica tube makes packing, shipping, and handling difficult. Typically, a layer of polyimide is coated on the outside of the fused silica capillary for protection. However, if the polyimide layer has incurred even a small scratch during production or handling, it will lose its protective effect and the capillary can break with just a gentle touch.

In the prior art, capillary columns to be used with a mass spectrometer have been transported as systems composed of a packed nano capillary that is bonded to a transport tube for connection with a mass spectrometer. The bonding agent is usually a fluoropolymer resin sleeve union. These column systems do not usually incorporate a frit into the column although an inlet filter may be packed separately with column. The user is left to determine whether the filter is required and to install it with the column. To assemble the column into a system, the user assembles the column input end into a fitting that matches the injector of the HPLC equipment being used. This involves placing the filter into the fitting, aligning the column and filter against the fitting leaving no dead space, and then tightening the assembly together. A skilled person is needed to assemble this end without breaking part of the column or introducing dead volume, that leads to bandspreading that negatively impacts the performance. During this operation, the transfer tube will be exerting stresses on the bonded joint possibly introducing dead volume into the joint.

The transport tube is required to connect the output of the Nano LC column to an electro-spray source of a mass spectrometer. The outlet of the prior art the column is connected to the transport tubing with a small piece of tubing that compresses the outside diameter of the mating capillaries and forms a flow path. This junction is very weak and susceptible to breakage or additional bandspreading.

Fused silica capillaries are extremely fragile and difficult to work with. Extreme care must be taken when handling and connecting the column to an HPLC system. A sleeve must be added to the prior art capillaries to allow tightening and swaging an end-fitting on the inlet end of the capillary column. A flexible sleeve is employed that compensates for the size of the capillary, which is too narrow for typical fittings.

There is a need, therefore, for a device that can protect the capillary column and form a user-friendly package that can be installed without extreme caution. This liquid transport capillary must alleviate the other shortcomings of the fragile fused silica capillary.

### SUMMARY OF THE INVENTION

The device built according to the invention overcomes the issues described above. The device is adapted to accommodate both a central nano capillary and a central nano column.

One embodiment of the present invention is directed to a device used to transport liquids through nano-scale capillary tubes. The device is built around a first cylinder having a wall. The wall has an interior surface and an exterior surface. This first cylinder has a first end, usually connected to an inlet mechanism, and a second end, usually connected to an outlet system. The interior volume of the first cylinder, surrounded by the interior surface, defines a chamber for receiving a liquid sample. A second cylinder is placed over the first end of the first cylinder. This second cylinder has a wall with an interior surface and an exterior surface, and the cylinder has a first end and a second end. When the second cylinder is placed concentrically about the first end of the first cylinder, the interior surface of the second end of the second cylinder is secured to the exterior surface of the first cylinder. The wall of the second cylinder has a thickness so that the resultant end of the assembly is thicker than the first cylinder. When the second wall is of a resilient material, it can be used to secure a fitting to the device. The second cylinder is sized so that the second cylinder occupies a position covering only a portion of the first cylinder. For liquid chromatography, the first and second cylinders are preferentially positioned with their first ends aligned, but the ends can be positioned relative to each other as best suits the application.

A third cylinder is placed over the second end of the first cylinder. The third cylinder has a wall with an interior surface and an exterior surface, and the third cylinder has a first end and a second end. When the third cylinder is placed concentrically about the second end of the first cylinder, the interior surface of the first end of the third cylinder is secured to the exterior surface of the first cylinder. The wall of the third cylinder has thickness so that the resultant end of the assembly is thicker than the first cylinder. This provides an easier to handle surface for mating with further cylinders such as a transfer tube. The third cylinder is sized so that the third cylinder occupies a position covering only a portion of the first cylinder. The second end of the third cylinder may extend beyond the limits of the second end of the first cylinder, but that relationship may be varied as required for connection purposes. In a preferred embodiment, the second end of the third cylinder projects outward from the second end of the first cylinder to provide a receiving pocket for a transport tube. Note that a portion of the first cylinder is not covered by either of the second cylinder or the third cylinder. In a preferred embodiment, the majority of the first cylinder is not covered.

A fourth cylinder sheathes the assembly of first, second and third cylinders. The fourth cylinder has a wall having an interior surface and an exterior surface. The first end of the fourth cylinder overlaps and is fastened to a portion of the first cylinder/second cylinder assembly and the second end overlaps and is fastened to the first cylinder/third cylinder assembly. In a preferred embodiment, the second end of the fourth cylinder covers the region where the third cylinder covers the first cylinder and extends to the second end of the third cylinder and in some cases beyond the second end. The fourth cylinder, so connected, stabilizes and supports the first, second and third cylinders by keeping the cylinders in a constant relationship and providing thickness to support connections to fluid transport means.

The device described above has superior operating characteristics when installed in a nano-scale fluid transport system because the assembly is manufactured with better tolerances than can be achieved in the field. Further, the scale of the device is easier to handle allowing a technician to install it more easily. The device can be manufactured to accommodate a known connection configuration, so that dead space in the resultant connection is minimized.

In a preferred embodiment, the first cylinder is implemented as a column, where the chamber is filled with chromatographic media. A frit may be formed in either or both ends of the first cylinder to secure the media in the chamber and to filter liquids entering and exiting the column. The device with a central column is well suited to be field fitted with a fitting compatible with the HPLC equipment being used. Further, the open end of the third cylinder is ready to receive a transport tube that can be butted flush with the second end of the column.

In a further embodiment, a fifth cylinder is added to the device previously described. A conduit through the fifth cylinder that can transport a liquid is defined by an interior surface. When the first end of the fifth cylinder is placed inside the second end of the third cylinder, the external surface engages with the interior surface of the third cylinder. In order to limit dead space, the first end of the fifth cylinder is butted against the second end of the first cylinder leaving no space therebetween. For best performance, the outside diameter of the fifth cylinder is substantially equal to the outside diameter of the first cylinder and the diameter of the conduit is equal or less than the diameter of the chamber of the first cylinder. It is preferred that the diameter of the conduit be less than the diameter of the chamber for liquid chromatography applications. The fifth cylinder may be substantially longer than the other cylinders and function as transport tube to, for instance, a mass spectrometer.

In an advantageous embodiment of the devices described above, the fourth cylinder is a tube of heat shrinkable material. The inner diameter of the fourth cylinder before shrinking is approximately the same as the outer diameter of the second and third cylinders, which are approximately equal. This allows the fourth cylinder to be easily slipped over the first, second and third cylinder assembly. The inner diameter of the heat shrink fourth cylinder, once shrunken, is approximately one-half the pre-shrunken diameter. In a preferred configuration, the shrunken inner diameter of the fourth cylinder is greater than the outer diameter of the first cylinder, allowing the fourth cylinder to protect the first cylinder without limiting its flexibility. The shrinking action of the fourth cylinder retains the cylinders in the fixed relationship of their assembly, making the whole assembly more immune to shocks and breakage. When the fifth cylinder, or transfer tube, is joined to the assembly of cylinders before the fourth cylinder is threaded over the assembly, the fourth cylinder may extend beyond the second end of the third cylinder. While the in the preferred embodiment, where the first and fifth cylinders have the same outer diameter, the heat shrunk cylinder will not grip the outer surface of the fifth cylinder, it will provide support to the butted junction between the first and fifth cylinders.

In one embodiment, the invention is implemented as a liquid chromatography column device with a column that is sized and dimensioned for chromatographic use. The column element has an internal cavity with a first and a second end and a longitudinal axis. A first cylindrical element is disposed about the column first end, forming a reinforced first region of the column. A second cylindrical element is disposed about the column second end. A third cylindrical element has a first end concentrically disposed on the first cylindrical element and a second end concentrically disposed on the second cylindrical element. The third cylindrical element is secured to the cylindrical elements that are encircled thereby stabilizing the liquid chromatography column while allowing it to remain flexible. The column device so assembled is ready to be directly coupled to liquid chromatography equipment in a manner that minimizes column dead volume.

This column device is preferred when the column is nano sized, such as those used for nano-spray applications. The column, in some embodiments, has the external surface of the wall covered by a protective coating applied to the column during manufacturing of the capillary that is the basis of the column. In some embodiments, the concentric first column end and end of the first cylindrical element co-terminate in a plane perpendicular to the longitudinal axis providing a flat surface that can be attached to an injector without increased bandspread.

In one embodiment, the column second end terminates at a midpoint of the second cylindrical element. This provides a socket for a transport tube to be inserted in the field. Alternately, the column is made with a transport tube having a wall structure defining a tubing cavity installed in the second end of the second cylindrical element. Installing the transport tube during manufacture of the column device allows fixtures to be used that minimize bandspreading and assure that the first end of the tubing and the second end of the column element are disposed in butting relationship and are perpendicular to the longitudinal axis of the column element. In an embodiment, the second cylindrical element holds the column element and the tubing together.

In a further embodiment, the liquid chromatography column described above also comprises a fitting disposed about and secured to the reinforced first region of the column element. The fitting is installed so that a portion of the reinforced first region protrudes from a first side of the fitting with a larger portion of the reinforced first region extending under the fitting and along a portion of the column. The fitting manufacturer typically specifies the extent of the protrusion of the column element from the fitting. One fitting used comprises a ferrule portion and a nut portion. The ferrule portion is crimped to the reinforced first region while the nut portion slides freely over the external surface of the first cylindrical element. The nut is retained by the third cylindrical element that is disposed around the second end of the first cylindrical element and provides too big a diameter to pass under the nut. In one embodiment, the capillary of the column element is made of fused silica, the first cylindrical element is made of polyetheretherketone (PEEK®) material, the second cylindrical element is made of a fluoropolymer resin such as Teflon® FEP material and the third cylindrical element is made of a heat-shrink tubing.

### DESCRIPTION OF THE DRAWINGS

For a fuller understanding of the nature and advantages of the invention, reference should be had to the detailed description taken in conjunction with the accompanying drawings in which:

FIG. 1A is a cross sectional view of a device according to the invention;

FIG. 1B is a cross sectional view of a device with a frit according to the invention;

FIG. 2 is a cross sectional view of a device with a transport tube according to the invention;

FIG. 3 is a cross sectional view of a device with a processed central cylinder according to the invention;

FIG. 4 is a cross sectional view of a device according to the invention;

FIG. 5 is a cross sectional view of a device with heat guards according to the invention;

FIG. 6 is a cross sectional view of a device with a fitting according to the invention;

FIG. 7 is a cross sectional view of a device with a fitting and transport tube according to the invention;

FIG. 8 is a cross sectional view of the device of FIG. 7 with a frit according to the invention; and

FIG. 9 is a cross sectional view of the device of FIG. 8 with a heat shrunk enclosing cylinder according to the invention.

### DETAILED DESCRIPTION

The present invention will be described in detail as a device for transporting liquids, performing chromatography and linking other instruments including, by way of example, a mass spectrometer to a liquid chromatograph. However, it must be appreciated that these are preferred embodiments and the invention can be applied in other ways as will be appreciated by those who are skilled in the art.

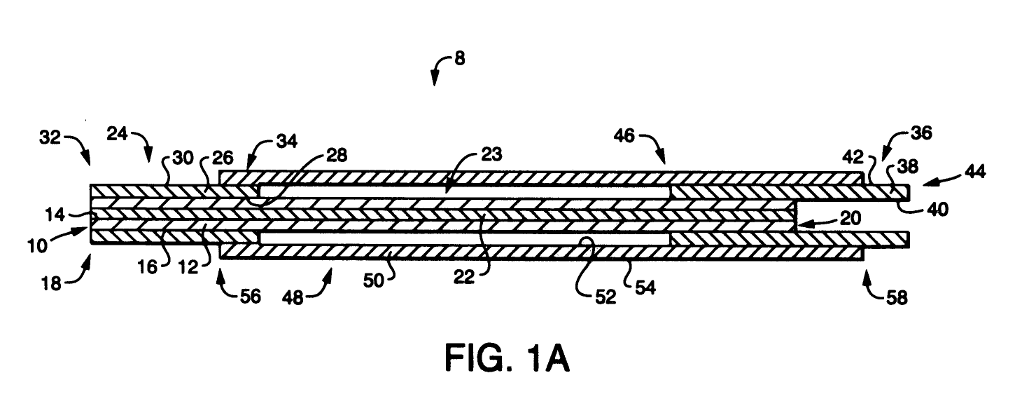

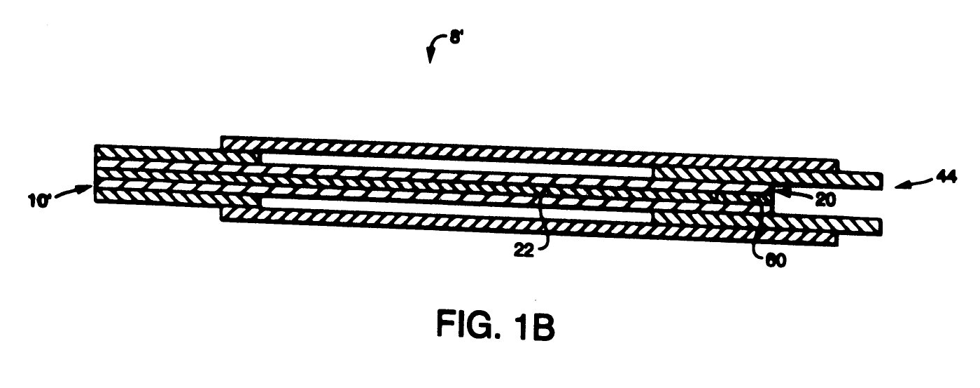

A preferred embodiment of the invention is used to transport liquids through nano-scale capillary tubes. FIG. 1A illustrates a basic version of this device 8. The device is built around a first cylinder 10 having a wall 12. The wall 12 has an interior surface 14 and an exterior surface 16. This first cylinder has a first end 18, usually connected to an inlet mechanism, and a second end 20, usually connected to an outlet system. The interior volume of the first cylinder 10, surrounded by the interior surface 14, defines a chamber 22 for receiving a liquid sample.

A second cylinder 24 is placed about the first end 18 of the first cylinder 10. This cylinder 24 has a wall 26 with an interior surface 28 and an exterior surface 30, and the cylinder 24 has a first end 32 and a second end 34. When the second cylinder 24 is placed concentrically about the first end 18 of the first cylinder 10, the interior surface 28 of the second cylinder 24 is secured to the exterior surface 16 of the first cylinder 10 by methods such bonding or crimping as are known in the industry. The wall 26 of the second cylinder 24 has a thickness so that the resultant end of the assembly is thicker than the first cylinder 10. When the second wall 26 is of a resilient material, it can be used to secure ends such as a fitting (not shown) to the device. The second cylinder 24 is sized so that the second cylinder 24 occupies a position covering only a portion of the first cylinder 10. The first and second cylinders 10, 24 are shown in FIG. 1 with their first ends 18, 32 aligned. Alternately, the ends can be positioned relative to each other as best suits the application. However, when the application is liquid chromatography, aligning the ends is preferred.

A third cylinder 36 is placed over the second end 20 of the first cylinder 10. This cylinder 36 has a wall 38 with an interior surface 40 and an exterior surface 42, and the third cylinder 36 has a first end 46 and a second end 44. When the third cylinder 36 is placed concentrically about the second end 20 of the first cylinder 10, the interior surface 40 of the third cylinder 36 is secured to the exterior surface 16 of the first cylinder 10 by methods such as bonding, press fit, or by resilience in the material of the third cylinder. The wall 38 of the third cylinder 36 has thickness so that the resultant end of the assembly is thicker than the first cylinder 10. This provides an easier to handle surface for mating with further cylinders such as a transfer tube. The third cylinder 36 is sized so that the third cylinder 36 occupies a position covering only a portion of the first cylinder 10. FIG. 1 illustrates the second end 44 of the third cylinder 36 extending beyond the limits of the second end 20 of the first cylinder 10, but that relationship may be varied as required for connection purposes. In a preferred embodiment, the second end 44 of the third cylinder 36 projects outward from the second end 20 of the first cylinder 10 to provide a receiving pocket for a transport tube. Note that a portion 23 of the first cylinder 10 is not covered by either of the second cylinder 24 or the third cylinder 36. In a preferred embodiment, the majority of the first cylinder 10 is not covered.

A fourth cylinder 48 sheathes the assembly of first, second and third cylinders 10, 24, 36. The fourth cylinder 48 has a wall 50 having an interior surface 52 and an exterior surface 54. The first end 56 of the fourth cylinder overlaps and is fastened to a portion of second cylinder 24 and the second end 58 overlaps and is fastened to the third cylinder 36. In a preferred embodiment, the second end 58 of the fourth cylinder 48 covers the region where the third cylinder 36 covers the first cylinder 10 and extends almost to the second end 44 of the third cylinder 36. The fourth cylinder 48, so connected, stabilizes and supports the first, second and third cylinders by keeping the cylinders in a constant the relationship and providing thickness to support connections to fluid transport means.

The device described above has superior operating characteristics when installed in a nano-scale fluid transport system because the assembly can be manufactured with better tolerances than can be achieved in the field. Further, the scale of the device is larger and easier to handle allowing a technician to install it more easily. The device can be manufactured to accommodate the connection configuration of a site, so that dead space in the resultant connection is minimized. When a fluid transport tube will be installed in the field, it is preferable that the third and fourth cylinders 36, 48 be made of a transparent material so that the technician can see the quality of the joint between the transport tube and the first cylinder 10 (flow joint) to minimize dead volume.

In a preferred embodiment shown in FIG. 1B, the first cylinder 10′ is implemented as a column, where chamber 22 is filled with HPLC packing material as is known in the industry. A frit 60 may be formed in either or both ends of the first cylinder 10′ to secure the media in the chamber 22 and to filter liquids entering and exiting the column 10′. The device 8′ with a central column 10′ is well suited to be field fitted with a fitting compatible with the HPLC equipment being used. Further, the open end 44 of the third cylinder is ready to receive a transport tube that can be joined flush with the second end 20 of column 10′.

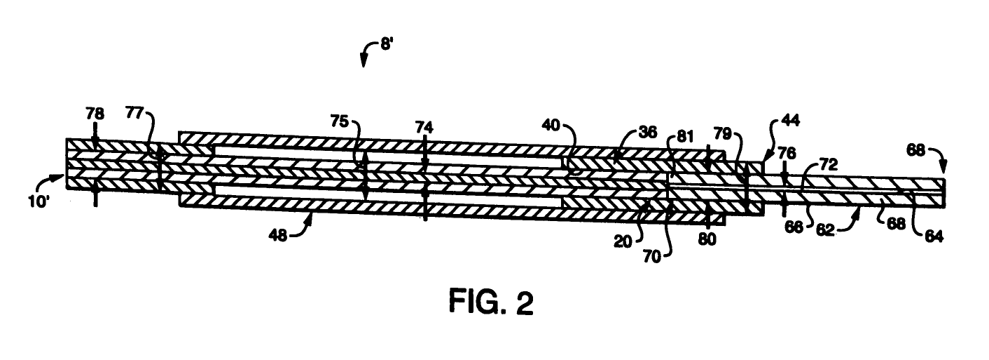

In a further embodiment as shown in FIG. 2, a fifth cylinder 62 is added to the device 8′ previously described. The fifth cylinder 62 has a wall 68 with an interior surface 64 and an exterior surface 66, and the fifth cylinder has a first end 70 and a second end 68. A conduit 72 through the fifth cylinder 68 that can transport a liquid is defined by the interior surface 64. When the first end 70 of the fifth cylinder 68 is placed inside the second end 44 of the third cylinder 36, external surface 66 engages with the interior surface 40 of the third cylinder 36. In order to limit dead space, the first end 70 of the fifth cylinder 68 is butted against the second end 20 of the first cylinder 10′ leaving no space therebetween. For best performance, the outside diameter 80 of the fifth cylinder 62 is substantially equal to the outside diameter 78 of the first cylinder 10′ and diameter 76 of the conduit 72 is equal or less than the diameter 74 of the chamber 22 of the first cylinder 10′. It is preferred that the diameter 76 of the conduit 72 be less than the diameter 74 of the chamber 22. The fifth cylinder 62 may be substantially longer than the other cylinders functioning as transport tube to, for instance, a mass spectrometer.

In an advantageous embodiment of the devices described above, the fourth cylinder 48 is a tube of heat shrinkable material. The inner diameter 75 of the fourth cylinder 48 before shrinking is approximately the same as the outer diameter 77 of the second cylinder 24, which is approximately equal to the outer diameter 79 of the third cylinder 36. This allows the fourth cylinder to be easily slipped over the first, second and, third cylinder assemblies. The inner diameter 75 of the shrunken heat shrink fourth cylinder 48 is approximately one-half the pre-shrunken diameter. In a preferred configuration, the shrunken inner diameter of the fourth cylinder 48 is greater than the outer diameter 78 of the first cylinder 10′, allowing the fourth cylinder 48 to protect the first cylinder without limiting its flexibility. The shrinking action of the fourth cylinder retains the cylinders 10′, 24 and 36 in the fixed relationship of their assembly, making the whole assembly more immune to shocks and breakage. When the fifth cylinder 62 is joined to the device 8′ before the fourth cylinder 48 is threaded over the assembly, the fourth cylinder 48 may extend beyond the second end 44 of the third cylinder 36. While in the preferred embodiment, where the first and fifth cylinders 10′, 62 have the same outer diameter, the heat shrunk cylinder will not grip the outer surface 66 of the fifth cylinder 62, it will provide the support to the butted junction 81 between the first and fifth cylinders 10′, 62.

In most embodiments, the first cylinder 10, and fifth cylinder 62 are very flexible being composed of nano diameter silica glass. The second cylinder 24 and third cylinder 36, having a larger inner diameter, exhibit less flexibility. This reduced flexibility provides support for the first and fifth cylinders 10, 62 and any junctions encased by the second and third cylinders 24, 36.

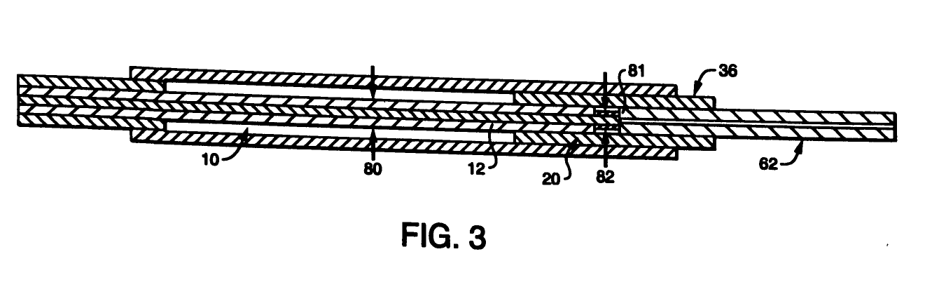

FIG. 3 illustrates an option to improve the flow junction 81. The thickness of the wall 12 at the second end 20 of the first cylinder 10 is reduced by a means such as heating so that the outer diameter 82 of the extreme second end 20 of the first cylinder 10 is reduced. This operation leaves a step down in diameter circumscribing the second end 20. If the third cylinder 36 is sized to be a tight fit about the normal diameter 80 of the first cylinder, then, when the third cylinder 36 is softened to allow the first cylinder 10′ to be threaded through the third cylinder 36, the stepped down region can get backfilled with softened material. This backfilled material is available for the fifth cylinder 62 to bond to when the fifth cylinder 62 is inserted while the third cylinder 36 is still softened. The backfilled material and tight-fitting third cylinder 36 significantly increases the strength of the junction between the first and fifth cylinders 10′, 62.

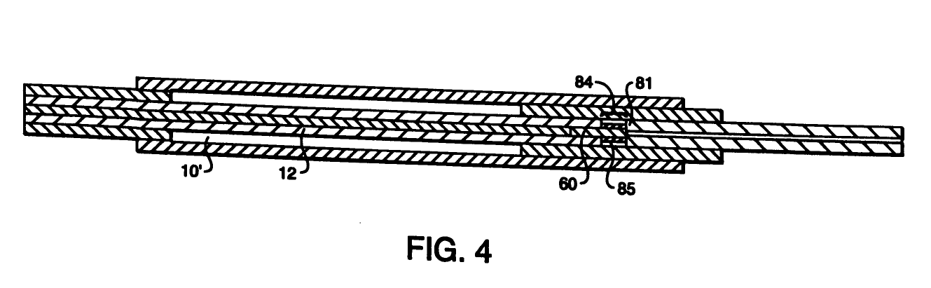

FIG. 4 illustrates that the flow junction 81 improvement can be combined with building a frit 60 in the first cylinder 10′ when the first cylinder is filled with HPLC packing material. One way of forming the frit 60 at the end 20 of the column 10 is by treating and then heating the treated HPLC packing material. In a last step, the very end 85 of the frit 60 is sintered. During the sintering step, the wall 12 is reduced in thickness for length 84. This step provides a self-contained frit 60 while providing the structure to improve the bond around junction 81 as discussed above.

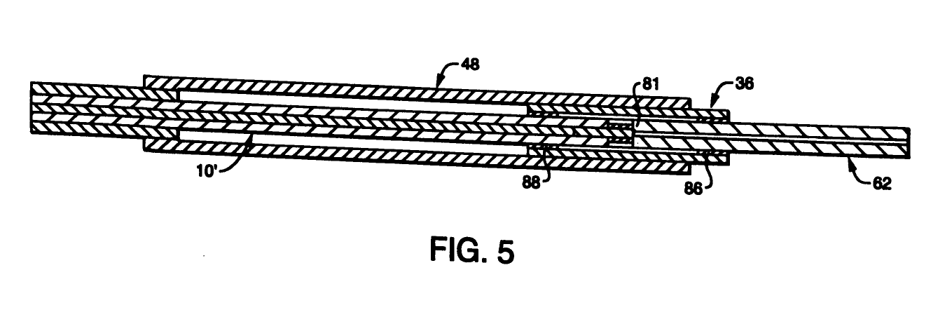

FIG. 5 illustrates an alternate assembly in the region of the third cylinder 36. When it is desired to further isolate the first and fifth cylinders 10′, 62 from any heating effects while shrinking the fourth cylinder 48, heat protecting tubes 86, 88 are placed around the first and fifth cylinders respectively before the third cylinder is installed. When the third cylinder is installed, it is therefore spaced apart from the liquid carrying first and fifth cylinders 10′, 62. In applications where the third cylinder is softened before being installed to facilitate forming the junction 81, the heat protecting tubes 86, 88 prevent any softened material from entering the fluid carrying portions of the cylinders. Further, when the fourth cylinder 48 is heated to cause the shrinking, the tubes 86, 88 isolate the first and fifth cylinders 10′, 62 from that heat.

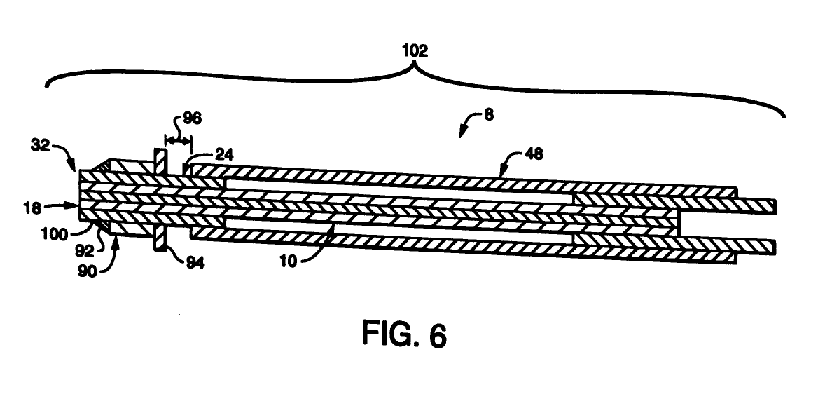

FIG. 6 illustrates an installation of a fitting 90 on the nano capillary transport device 8 creating a insertable device 102. The fitting shown has a ferrule 92 and a nut 94 as is known in the art. The specifics of the fitting chosen are tailored to match the port of the instrument used. The ferrule 92 is swaged onto the second cylinder 24 either in a bonding action that connects the three components, the ferrule 92, second cylinder 24, and first cylinder 10, together or in a separate operation after the first and second cylinders 10, 24 have been joined. The spacing between the ferrule 92 front edge 100 and the ends of the cylinders 18, 32 is specified for each fitting 90 and the insertable device 102 is manufactured to precisely meet these specifications, thereby limiting dead volume. When the fourth cylinder 48 is installed, it terminates short of the fitting 90 providing a space 96 to allow the nut 94 to be retracted from the ferrule 92.

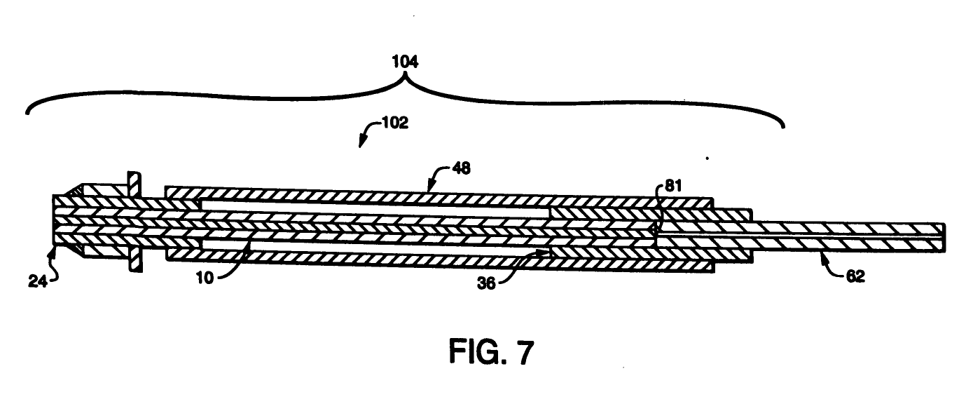

In FIG. 7, the insertable device 102 is made more installable by connecting the fifth cylinder 62 to the insertable device. The flow junction 81 between the first and fifth cylinders 10, 62 is formed in the factory where conditions are controlled and repeatable. In manufacturing device 104, the fourth cylinder 48 is not put in place until after the fifth cylinder 62 is joined to the insertable device 102, allowing an opaque material to be used for the fourth cylinder 48. This allows the joining of the flow junction 81 to be carried out under a microscope, minimizing dead volume. Teflon° FEP is one preferred material for third cylinder 36 because it is transparent, allowing the joining to be visually monitored. Although FIG. 7 illustrates the fourth cylinder 48 terminating short of the end of the third cylinder 36, is it preferred to extend the fourth cylinder 48 a small distance down the length of the fifth cylinder 62 to provide support.

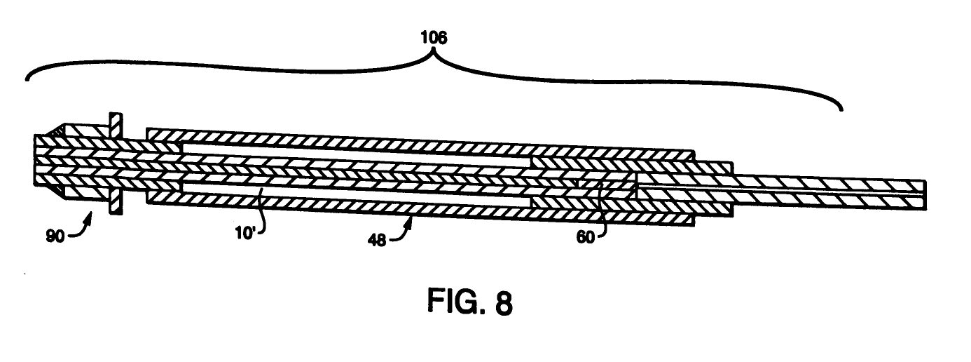

FIG. 8 illustrates a device 106 with a column 10′ incorporating a frit 60 built up like in the previous device 104. The fitting 90 makes device 106 insertable while the integration of the cylinders into a unit by the fourth cylinder 48 makes the device safe to handle with reasonable rather than extreme care.

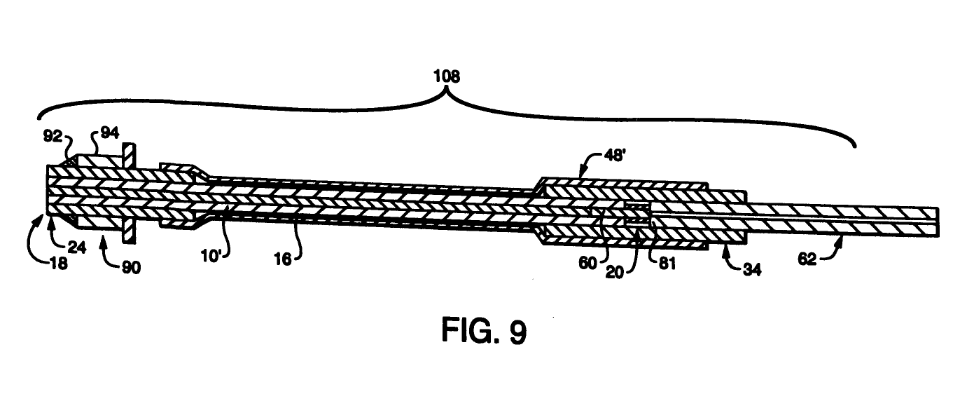

FIG. 9 illustrates a device 108 incorporating all the features previously discussed. The first cylinder 10′ is configured as a column with a frit 60 that has been sintered at its second end 20. The first and fifth cylinders 10′, 62 are joined at the mid-point of the third cylinder 36 with a butt joint 81 that allows no dead volume. The fitting 90 is installed at the first, inlet, end 18 of the column 10′ with room for the nut 94 to disengage from the ferrule 92. The fourth cylinder has been heat shrunk and is in its shrunken state 48′ where it has less thickness and grips the second and third cylinders 24, 36. Note that the shrunken fourth cylinder 48′ comes close to the first cylinder 10′ without gripping the outer surface 16.

The inside diameter of the first and fifth cylinders ranges between 5 μm and 180 μm. The diameter of the fifth cylinder 62 is equal or less than the diameter of the first cylinder 10.

A preferred method of making device 108 starts with filling a first nano-capillary 10 with HPLC packing material. The ends of the HPLC packing material are processed to form frits 60 at the ends of the first capillary. The outlet end 20 is processed such that a reduced outer diameter is formed for a portion 84 of end 20. The inlet end 18 is processed without this effect. The second cylinder 24 made of polyetheretherketone resin (PEEK™), chosen for its resistance to chemicals and resilience, is slipped over the first, inlet, end 18 of the first capillary 10′. The concentric ends 18, 32 are placed in a fixture (not show) that aligns the ends as required by the fitting 90 to be used. The fitting ferrule 92 is slipped over the first and second cylinders 10′, 24 and into the fixture. The ferrule 92, second cylinder 24 and first capillary 10′ are swaged together forming the inlet side of the device 108. The nut portion 94 of the fitting 90 is slid over the first cylinder 10′ and the first and second cylinder reinforced section, to rest near the ferrule 92.

The third cylinder 36, preferably made of Teflon® FEP that has an inner diameter slightly less than the outer diameter of the first cylinder 10′ is heated until soft and moldable. The second end 20 of the first cylinder 10′ is pushed through the softened third cylinder 36. Because of the reduced outer diameter of this end 20, it passes easily through the third cylinder 36 with no material from the third cylinder 36 blocking the chamber in the first cylinder 10′. However, the inner diameter of the third cylinder is expanded by the passage of the full diameter part of the end 20. Once the end 20 has passed through the whole length of the third cylinder 36, it is retracted to the midpoint of the third cylinder. Some of the material of the third cylinder 36 accumulates where the first cylinder 10′ changes diameter. The end 20 of the first cylinder 10′ is placed under a microscope focused where the flow junction 81 will be formed. The first end 70 of the fifth cylinder 62 is fed into the third cylinder 36 until the first and fifth cylinders 10′, 62 are butted against each other with no dead volume between. The third cylinder is allowed to cool and it shrinks around the enclosed first and fifth cylinders 10, 62 gripping them.

Heat shrink tubing, to form the fourth cylinder 48, is cut to a length that will extend from slightly after the fitting nut 94, along the exposed length of the first column 10′, over the third cylinder and a distance comparable to the length of the second cylinder 24 along the fifth cylinder length. This tubing has an inner diameter approximately equal to the outer diameter of the second and third cylinders 10′, 62 or slightly larger. It will shrink to half its diameter when heated. The fourth cylinder 48 is threaded from the second end 68 of the fifth cylinder 62 until it is positioned slight before the fitting nut 94 and covers the cylinders. Heat is applied to the fourth cylinder 48 to shrink it. The fourth cylinder deforms gripping the second and third cylinders 24, 36 and coming near to the first and fifth cylinders.

The assembly is easy to put together while achieving a high degree of precision in the placement of the parts. Bandspreading is minimized because the dead volume is controlled. The resultant device is resilient and only requires that the inlet end 18 be connected utilizing the fitting 90 and that the second end 68 of the fifth cylinder 62 be fed to an electro-spray source (for mass spectroscopy) where precision placement is less important.

One skilled in the art will appreciate further features and advantages of the invention based on the above-described embodiments. Accordingly, the invention is not to be limited by what has been particularly shown and described, except as indicated by the appended claims.

1. A device for transporting liquids comprising:
a first cylinder having a wall, having an interior surface and an exterior surface, and a first end and second end, said interior surface defining a chamber for receiving a liquid sample;
a second cylinder having a wall, having an interior surface and an exterior surface, and a first end and a second end, said interior surface of said second end of said second cylinder secured to said exterior surface of said first end of said first cylinder, said wall of said second cylinder having a thickness, and said second cylinder occupying a position on said first cylinder such that a portion of said first cylinder is uncovered by said second cylinder;
a third cylinder having a wall having an interior surface and an exterior surface, and a first end and a second end, said interior surface of said first end of said third cylinder secured to said exterior surface of said first cylinder about said second end of said first cylinder, said third cylinder wall having a thickness, and said third cylinder occupying a position on said first cylinder such that a portion of said first cylinder is uncovered by said second cylinder; and,
a fourth cylinder having a wall having a interior surface and an exterior surface, and a first end and a second end, said interior surface of said fourth cylinder secured to said exterior surface of said second cylinder and said exterior surface of said third cylinder to stabilize and support said first, second and third cylinders by maintaining a relationship among said cylinders and providing thickness to support connections to fluid transport means.

2. The device of claim 1 wherein said third cylinder projects outward from said second end of said first cylinder to expose the interior surface wall of said second end of said third cylinder for receiving a fifth cylinder.

3. The device of claim 2 wherein said device further comprises a fifth cylinder, said fifth cylinder having a wall having an interior surface and an exterior surface, and a first end and a second end, said interior surface defining a conduit for receiving a liquid, said first end of said fifth cylinder received in said second end of said third cylinder.

4. The device of claim 3 wherein said conduit has a diameter and said chamber has a diameter, said diameter of said conduit is no larger than said diameter of said chamber.

5. The device of claim 4 wherein said diameter of said conduit is less than said diameter of said chamber.

6. The device of claim 3 wherein an outside diameter of said first cylinder and an outside diameter of said fifth cylinder are substantially identical.

7. The device of claim 6 wherein said second end of said first cylinder and said first end of said fifth cylinder are held in a tightly butted relationship with each other by said third cylinder.

8. The device of claim 2 wherein said second end of said first cylinder is positioned at an approximate midpoint of said third cylinder.

9. The device of claim 1 wherein said first cylinder and said fourth cylinder have a flexibility.

10. The device of claim 9 wherein said second and third cylinders are more rigid than said first and fourth cylinders.

11. The device of claim 1 wherein said exterior surface of said wall of said second cylinder is for receiving a fitting assembly.

12. The device of claim 1 wherein said second cylinder is positioned on said first cylinder such that the respective said first ends of said cylinders are aligned.

13. The device of claim 1 wherein said chamber of said first cylinder contains a chromatographic media.

14. The device of claim 13 wherein a frit is formed in one end of said first cylinder, said frit positioned to contain said chromatographic media in said chamber.

15. The device of claim 1 wherein said first cylinder has an inside diameter between 5 μm and 200 μm.

16. The device of claim 1 wherein said second cylinder has an inside diameter approximately equal to an outside diameter of said first cylinder.

17. The device of claim 1 wherein said third cylinder has an inside diameter approximately equal to an outside diameter of said first cylinder.

18. The device of claim 1 wherein said fourth cylinder has an inside diameter approximately equal to an outside diameter of said second cylinder and an outside diameter of said third cylinder.

19. The device of claim 1 wherein said fourth cylinder is a comprised of a heat shrinkable material.

20. The device of claim 19 wherein an inside diameter of said fourth cylinder before heat shrinking is approximately equal to an outside diameter of said second cylinder and an outside diameter of said third cylinder and an inside diameter of said fourth cylinder after heat shrinking compresses said second and third cylinders and is larger than an outside diameter of said first cylinder.

21. A method of making a device for transporting a fluid, comprising the steps of:
providing a first cylinder having a wall having an interior surface and an exterior surface, and a first end and second end, said interior surface defining a chamber for receiving a liquid sample;
placing a second cylinder having a wall having an interior surface and an exterior surface, and a first end and a second end, with said interior surface of said second end secured to said exterior surface of said first end of said first cylinder, said wall having a thickness, and said second cylinder occupying a position on said first cylinder such that a portion of said first cylinder is uncovered by said second cylinder;
placing a third cylinder having a wall having an interior surface and an exterior surface, and a first end and a second end, with said interior surface of said first end of said third cylinder secured to said exterior surface of said second end of said first cylinder, said wall having a thickness, and said third cylinder occupying a position on said first cylinder such that a portion of said first cylinder is uncovered by said second cylinder; and,
placing a fourth cylinder having a wall having a interior surface and an exterior surface, and a first end and a second end, with said interior surface of said fourth cylinder secured to said exterior surface of said second cylinder and said exterior surface of said third cylinder thereby stabilizing and supporting said first, second and third cylinders by maintaining a relationship among said cylinders and providing thickness to support connections to fluid transport means.

22. The method of claim 21 wherein said third cylinder projects outward from said second end of said first cylinder to expose the interior wall of said second end of said third cylinder for receiving a fifth cylinder.

23. The method of claim 22 further comprising placing a fifth cylinder having an wall, having an interior surface defining a conduit for receiving liquid and an exterior surface, and a first end and a second end, with said first end of said fifth cylinder received in said second end of said third cylinder.

24. The method of claim 23 wherein said conduit has a diameter and said chamber has a diameter, said diameter of said conduit being no larger than said diameter of said chamber.

25. The method of claim 23 wherein said third cylinder is formed of a material that becomes deformable when heated and said method further comprises softening said third cylinder before placing said fifth cylinder within said second end of said third cylinder.

26. The method of claim 21 wherein said exterior wall of said second cylinder is for receiving a fitting assembly.

27. The method of claim 21 wherein said fourth cylinder is a comprised of a heat shrinkable material.

28. The method of claim 27 further comprising heating said fourth cylinder causing said fourth cylinder to deform around said second and third cylinders and bring said interior surface of said fourth cylinder closer to said exterior surface of said first cylinder.

29. A liquid chromatography column comprising:
a column sized and dimensioned for chromatographic use, said column having a wall defining an internal cavity with a first column end and a second column end and a longitudinal axis;
a first cylindrical element disposed about said column first end, said first cylindrical element having a first end and a second end, forming a reinforced first region of said column;
a second cylindrical element disposed about said column second end and
a third cylindrical element disposed about said column, first cylindrical element and second cylindrical element and held to said first cylindrical element and said second cylindrical element, stabilizing said liquid chromatography column that remains flexible and ready to be directly coupled to liquid chromatography equipment in a manner that minimizes column dead volume.

30. The column of claim 29 wherein said column is has an inside diameter between 5 μm and 180 μm.

31. The column of claim 29 wherein said wall encompasses any protective coating applied to the column during manufacturing of the column.

32. The column of claim 29 wherein said column second end terminates at a midpoint of said second cylindrical element.

33. The column of claim 29 further comprising a transport tube having a wall structure defining a tubing cavity, a first end of said tubing perpendicular to a longitudinal axis of said tubing disposed in butting relationship with said column second end inside said second cylindrical element, said column second end and said transport tube first end held together by said second cylindrical element.

34. The column of claim 29 wherein said first column end and said first end of said first cylindrical element coterminate in a plane perpendicular to said longitudinal axis.

35. The liquid chromatography column of claim 34 further comprising a fitting disposed about and secured to said reinforced first region of said column so that a portion of said reinforced first region protrudes from a first side of said fitting and a larger portion of said reinforced first region extends under said fitting and along a portion of said column.

36. The liquid chromatography column of claim 35 wherein said fitting comprises a ferrule portion and a nut portion.

37. The liquid chromatography column of claim 36 wherein said nut portion slides freely over an outer surface of said first cylindrical element.

38. The liquid chromatography column of claim 37 wherein said nut portion does not fit over said third cylindrical element disposed atop said first cylindrical element.

39. The liquid chromatography column of claim 38 wherein said fitting is a Valco® fitting.

40. The liquid chromatography column of claim 29 wherein said column is a silica based nano column is made of fused silica.

41. The liquid chromatography column of claim 29 wherein said first cylindrical element is made of PEEK®.

42. The liquid chromatography column of claim 29 wherein said second cylindrical element is made of Teflon® FEP material.

43. The liquid chromatography column of claim 29 wherein said third cylindrical element is made of heat-shrink material.

44. The device of claim 1 wherein a portion of said first cylinder is not covered by either of said second cylinder or said third cylinder.

45. The device of claim 1 wherein said wall of said first cylinder encompasses any protective coating applied to the first cylinder during manufacture.

46. The device of claim 14 wherein said frit is formed at said second end of said first cylinder.

47. The device of claim 1 wherein said first cylinder has a length between 50 mm and 250 mm

48. The method of claim 23 further comprising placing said first end of said fifth cylinder in a tightly butted relationship with said second end of said first cylinder.
